(19) United States
(12) Patent Application Publication
(10) Pub. No.: US 2009/0300692 A1
(43) Pub. Date: Dec. 3, 2009

(54) SYSTEMS AND METHODS FOR VIDEO STREAMING AND DISPLAY

(76) Inventors: Aditya A. Mavlankar, Stanford, CA (US); Jeonghun Noh, Stanford, CA (US); Pierpaolo Baccichet, Palo Alto, CA (US); Bernd Girod, Stanford, CA (US)

Correspondence Address: CRAWFORD MAUNU PLLC, 1150 NORTHLAND DRIVE, SUITE 100, ST. PAUL, MN, 55120, US

(21) Appl. No.: 12/131,622

(22) Filed: Jun. 2, 2008

(51) Int. Cl. H04N 7/173

(52) U.S. Cl. 725/94

(57) ABSTRACT

For display of, at a user device, a region of interest within video images and associated applications. In a particular example embodiment, a streaming video source provides streaming data to a user device, with the streaming data being representative of a sequence of images, and each image including a plurality of individually decodable slices. At the user device and for a particular image and a corresponding subset region of the image, less than all of the plurality of individually decodable slices are displayed in response to a current input indicative of the subset region. Future input indicative of a revised subset region is then predicted in response to images in the image sequence that have yet to be displayed and to previously received input. In other embodiments, multicasting methods, systems or arrangements provide streaming video to one or more user devices.

### FIELD OF INVENTION

This invention relates generally to streaming and display of video, and more specifically to systems and methods for displaying a region of interest within video images.

### BACKGROUND

Digital imaging sensors are offering increasingly higher spatial resolution. High-spatial-resolution videos can also be stitched from views captured from multiple cameras; this is also possible to do real-time using existing products. In general, high-resolution videos will be more broadly available in the future; however, challenges in delivering this high resolution content to the client are posed by the limited resolution of display panels and/or limited bit-rate for communications. In particular, time-sensitive transmissions can be particularly limited by the network bandwidth and reliability.

Suppose, for example, that a client limited by one of these factors requests a high spatial resolution video stream from a server. One approach would be to stream a spatially down sampled version of the entire video scene to suit the client's display window resolution or bit-rate. However, with this approach, the client might not be able to watch a local region-of-interest (ROI) in the highest captured resolution.

Another approach may be to buffer high-resolution data for future display. This can be useful to account for periodic network delays or packet losses. One problem with this approach is that it requires either that the entire image be sent in high-resolution or a priori knowledge of the ROI that the user device will display in the future. Sending the entire high-resolution image may be less than ideal as the size of the entire image file increases either due to increases in resolution and/or increases in the size of the entire image. For many implementations, this results in excessive waste in network bandwidth as much of the transmitted image may never be displayed or otherwise used. Unfortunately, another option, sending less than the entire image, may be less than ideal for certain applications, such as applications in which the region of interest changes. If the change in the region of interest cannot be known with certainty, the buffer may not contain the proper data to display the ROI. This could result in a delay in the actual change in the ROI or even in delays or glitches in the display. These and other aspects can degrade the user viewing experience.

### SUMMARY

The present invention is directed to approaches to systems and methods for displaying a region of interest within video images and associated applications. The present invention is exemplified in a number of implementations and applications including those presented below, which are commensurate with certain of claims appended hereto.

According to another example embodiment, the present invention involves use of a streaming video source. The video source provides streaming data to a user device, with the streaming data being representative of a sequence of images, and each image including a plurality of individually decodable slices. At the user device and for a particular image and a corresponding subset region of the image, less than all of the plurality of individually decodable slices are displayed in response to a current input indicative of the subset region. Future input indicative of a revised subset region, is then predicted in response to images in the image sequence that have yet to be displayed and to previously received input.

In more specific embodiments, the current input indicative of the subset region includes a user selection via a graphical interface, and the images in the image sequence (yet to be displayed) are buffered.

According to another example embodiment, the present invention involves use of a streaming video source that provides an image sequence, with the video source providing low-resolution image frames and sets of higher-resolution image frames. Each of the higher-resolution image frames corresponds to a respective subset region that is within the low-resolution image frames, and the embodiment includes:

receiving input indicative of a subset region of an image to be displayed;

displaying the indicated subset region using the higher-resolution image frames; and

predicting future input indicative of a revised subset region of the low-resolution image sequence in response to image frames not yet displayed and to previous input indicative of a subset region of the low-resolution image sequence.

In yet another example embodiment, the present invention is directed to providing streaming video to a plurality of user devices. The streaming video includes a plurality of individually decodable slices, and the embodiment includes:

providing less than all of the individually decodable slices to a particular peer, the provided less than all of the individually decodable slices corresponding to a region of interest;

displaying the region of interest at the particular peer;

receiving input indicative of a change in the region of interest;

responsive to the input, generating a list of video sources that provide at least one slice of the changed region of interest; and

responsive to the list of video sources, connecting the particular peer to one or more of the video sources to receive a slice of the subset of the plurality of slices.

The above summary of the present invention is not intended to describe each illustrated embodiment or every implementation of the present invention.

### BRIEF DESCRIPTION OF THE FIGURES

The invention may be more completely understood in consideration of the detailed description of various embodiments of the invention that follows in connection with the accompanying drawings, in which:

FIG. 1 shows a display screen at the client's side that includes two viewable areas, according to an example embodiment of the present invention;

FIG. 2 shows an overall system data flow, according to one embodiment of the present invention;

FIG. 3 shows a timeline for pre-fetching, according to one embodiment of the present invention;

FIG. 4 shows a processing flowchart, according to one embodiment of the present invention;

FIG. 5 shows temporally and spatially connected pixels, according to one embodiment of the present invention;

FIG. 6 shows the overview video (b_{w} by bₕ) is first encoded using H.264/AVC without B frames, according to one embodiment of the present invention;

FIG. 7 shows the pixel overhead for a slice grid and location of an ROI, according to one embodiment of the present invention;

FIG. 8 shows a long line of pixels that is divided into segments of lengths, consistent with one embodiment of the present invention;

FIG. 9 depicts the juxtaposition of expected column and row overheads next to the ROI display area (d_{w} by dₕ), according to one embodiment of the present invention;

FIG. 10 shows an end user device 1008 with a current ROI that includes slice A, according to one embodiment of the present invention;

FIG. 11 shows the end user from FIG. 10 with a modified ROI that includes slices A and Y, according to one embodiment of the present invention;

FIG. 12 shows a flow diagram for an example network implementation, consistent with an embodiment of the present invention; and

FIG. 13 shows an example where the ROI has been stationary for multiple few frames, according to one embodiment of the present invention.

While the invention is amenable to various modifications and alternative forms, examples thereof have been shown by way of example in the drawings and will be described in detail. It should be understood, however, that the intention is not to limit the invention to the particular embodiments shown and/or described. On the contrary, the intention is to cover all modifications, equivalents, and alternatives falling within the spirit and scope of the invention.

### DETAILED DESCRIPTION

Various embodiments of the present invention have been found to be particularly useful in connection with a streaming video source that provides streaming data (representing a sequence of images respectively including individually-decodable slices) to a user device. While the present invention is not necessarily limited to such applications, various aspects of the invention may be appreciated through a discussion of various examples using this context.

Consistent with certain embodiments of the present invention, a user device displays less than all of the plurality of individually decodable slices. This displayed subset image region can be modified via an input (e.g., user input or feature tracking input). Future input indicative of a revised subset region is predicted based upon images in the image sequence that have yet to be displayed and upon previously received input. The predicted input is used to determine which individually decodable slices are buffered. In certain embodiments, less than all of the plurality of individually decodable slices are transmitted to the user device. This can be particularly useful for reducing the network bandwidth consumed by the streaming video.

Consistent with one example embodiment of the present invention, a source provides a streaming video sequence to one or more user display devices. A particular user display device is capable of displaying a portion of an image from the entire video sequence. For instance, if an image from the video sequence shows a crowd of people, the displayed portion may show only a few of the people from the crowd. Thus, the data transmitted to a particular user device can be limited to the portion being shown and the device can limit image processing to only the reduced portion. In a particular instance, the displayed portion can change relative to the images of the video sequence. Conceptually, this change can be viewed as allowing for pan-tilt-zoom functionality at the user device.

A specific embodiment is directed to a video delivery system with virtual pan/tilt/zoom functionality during the streaming session such that the system can adapt and stream only those regions of the video content that are expected to be displayed at a particular client.

Consistent with a variety of standards (see, e.g., MPEG and IEEE), the word “slice” is used in connection with encoded data that contains data that when decoded is used to display a portion of an image. Individually decodable slices are slices that can be decoded without the entire set of slices for the instant image being available. These slices may be encoded using data from previous slices (e.g., motion compensation for P-slices), future slices (e.g., B-slices), or the slice encoding can stand on its own (e.g., I-slices). In some instances decoding of a slice may require some data from other (surrounding) slices, in so much as the required data does not include the other slices in their entirety, the original slice can still be considered an individual slice.

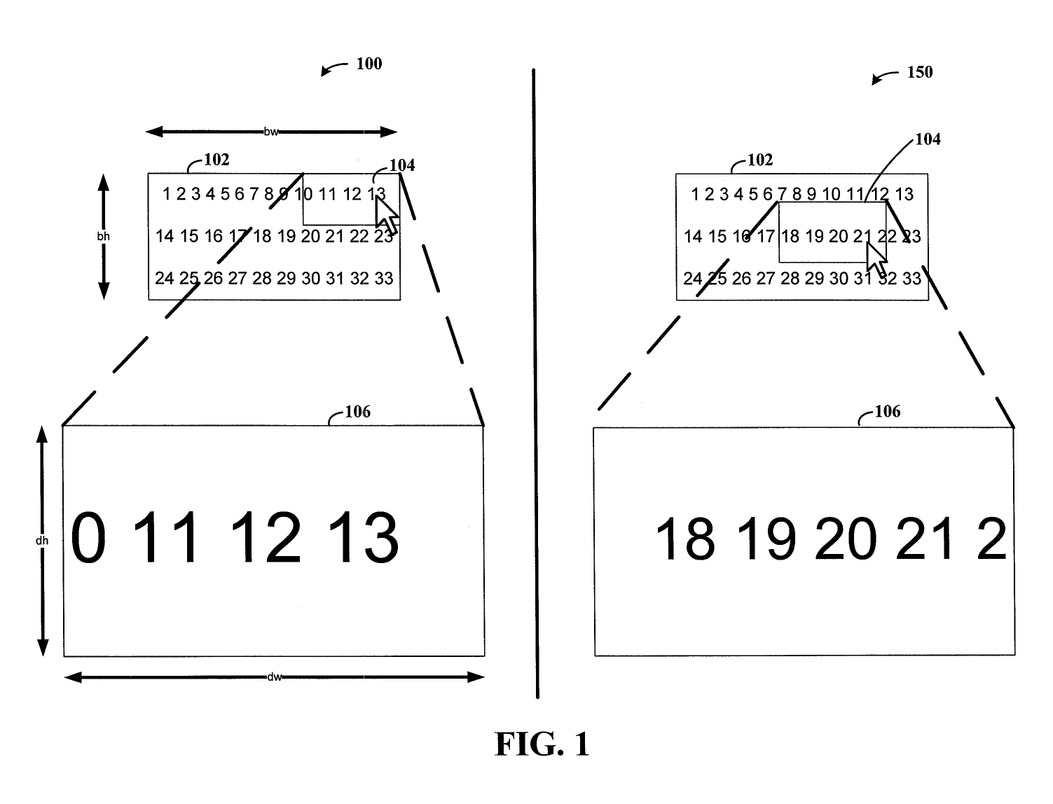

It can be desirable for video coding schemes to allow for sufficient random access to arbitrary spatial resolutions (zoom factors) as well as arbitrary spatial regions within every spatial resolution. In one instance, the system includes a user interface with real-time interaction for ROI selection that allows for selection while the video sequence is being displayed. As shown in FIG. 1, the display screen at the client's side consists of two areas. The first area 102 (overview display) displays a down sampled version (e.g., thumbnail) of the entire scene display area. This first area is b_{w} pixels wide and bₕ pixels tall. The second area 106 (ROI display) displays the client's ROI. This second area is d_{w} pixels wide and dₕ pixels tall.

In one instance, the zoom factor can be controlled by the user (e.g., with the scroll of the mouse). For a particular zoom factor, the ROI can be moved around by keeping the left mouse-button pressed and moving the mouse. As shown in FIG. 1, the location of the ROI can be depicted in the overview display area by overlaying a corresponding rectangle 104 on the video. The color, size and shape of the ROI 104 can be set to vary according to the factors such as the zoom factor. The overview display area 102 includes a sequence of numbers from 1 to 33. In practice, the overview display could contain video images of nearly any subject matter. For simplicity, however, the numbers of FIG. 1 are used to delineate different areas of the overview display area 102 and the corresponding displayed image.

Combination 100 represents a first setting for the ROI/rectangle 104. As shown, rectangle 104 includes a ROI that includes part of the number 10, and all of 11, 12 and 13. This portion of the image is displayed in the larger and more detailed section of second area 106. Combination 150 represents an altered, second setting for the ROT/rectangle 104. As shown, the modified rectangle 104 now includes the numbers 18, 19, 20, 21 and a portion of 22. Of particular note is that the modified rectangle includes a relatively larger section of overview image 102 (e.g., 4.5 numbers vs. 5.5 numbers, assuming that the underlying image has not been modified). Thus, the revised ROI from combination 100 to combination 150 represents both a movement in the 2-d (x, y) plane of the overview image 102 and a change in the zoom factor.

Although not explicitly shown, the overview picture will often change over time. Thus, the images displayed in both overview image 102 and ROI display 106 will change accordingly, regardless of whether the ROI/rectangle 104 is modified.

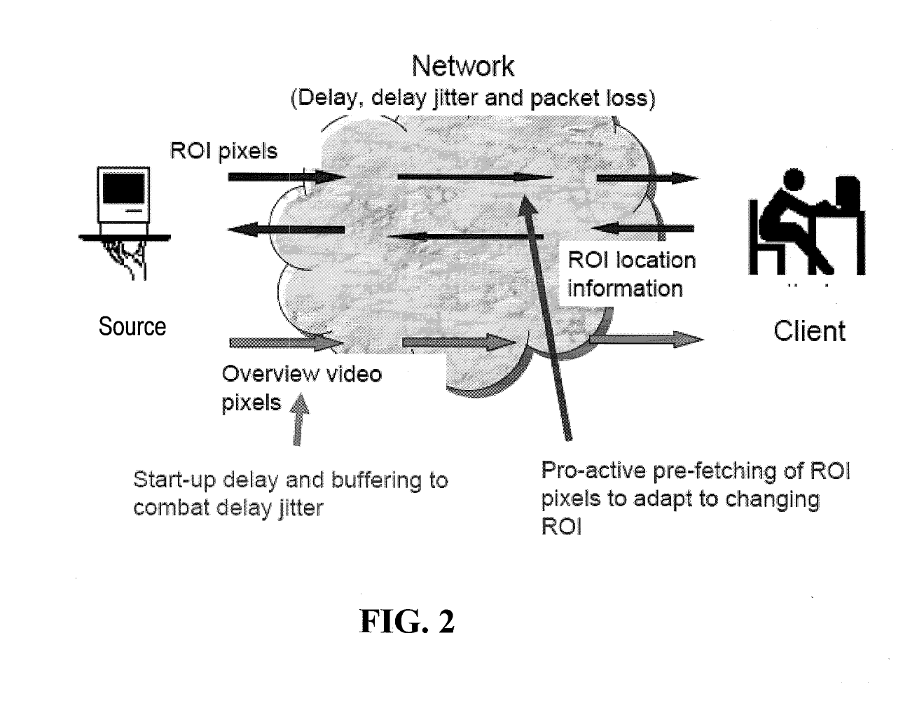

An overall system data flow is shown in FIG. 2, according to one embodiment of the present invention. The client indicates an ROI to the source. The ROI indication can include a 2-d location and a desired spatial resolution (zoom factor) and can be provided in real-time to the source (e.g., a server). The server then reacts by sending relevant video data which are decoded and displayed at the client's side. The server should be able to react to the client's changing ROI with as little latency as possible. However, streaming over a best-effort packet-switched network implies delay, delay jitter as well as loss of packets. A specific embodiment of the system is designed to work for a known value of the worst-case delay. Since the overview video can be set to always display the entire scene, a number of frames of the overview video are sent ahead of their actual display. These frames can be buffered at the client until needed for actual display. The size of such a buffer can be set to maintain a minimum number of frames of the overview video in advance despite a delay of the network.

For certain applications, the client's ROI is being decided by the user real-time at the client's side. Thus, the server does not have knowledge of what the future ROI will be relative to the display thereof. Meeting the display deadline for the ROI display area can be particularly challenging for the following reason; at the client's side, as soon as the ROI location information is obtained from the mouse, it is desirable that the requested ROI be rendered immediately to avoid detracting from the user-experience (e.g., a delay between a requested ROI and its implementation or a pause in the viewed video stream). In order to render the ROI spontaneously despite the delay of packets, aspects of the present invention predict the ROI of the user beforehand and use the prediction to pro-actively pre-fetch those regions from the server.

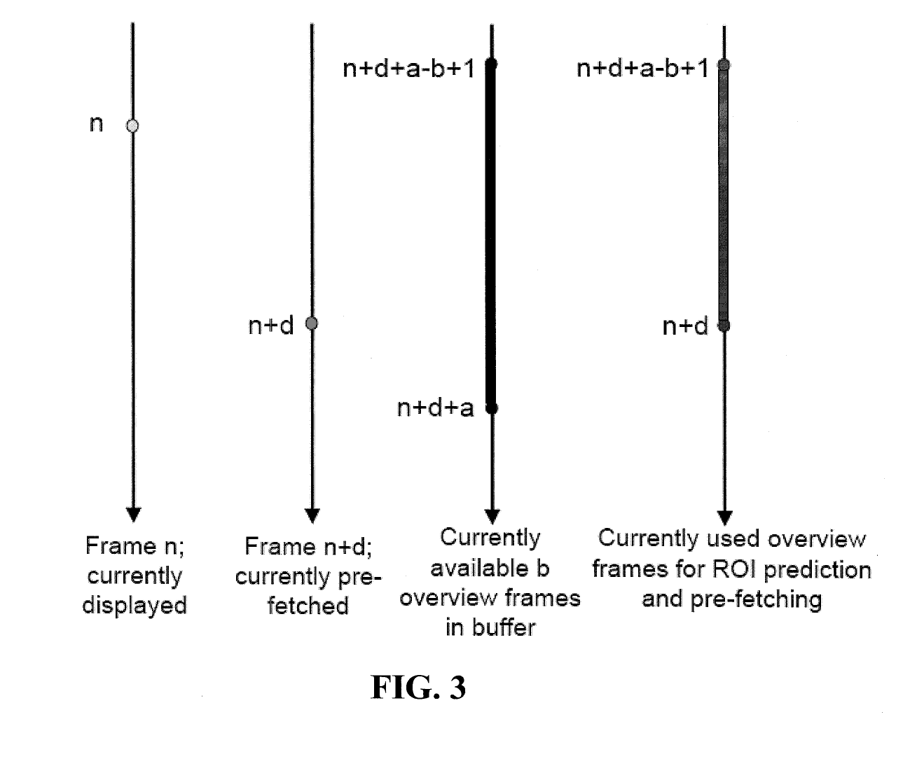

An example timeline for such pre-fetching is shown in FIG. 3. The look ahead is d, where d is the number of frame-intervals that are pre-fetched for the ROI in advance. The following two modes of interaction provide examples of how the ROI can be determined. In manual mode the user indicates his choice of the ROI (e.g., through mouse movements). The ROI d frame-intervals are predicted ahead of time. In tracking mode the user selects (e.g., by right-clicking on) an object in the ROI. The aim is to track this object automatically in order to render it within the ROI until the user switches this mode off. Note that in the tracking mode, the user need not actively navigate with the mouse. Examples of these modes will be discussed in more detail below.

In manual mode a prediction of the future ROI could be accomplished by extrapolating from the previous mouse moves up until the current instant in time. One prediction model involves a simple autoregressive moving average (ARMA) model for predicting the future viewpoint of the user in his work on interactive streaming of light fields. For further details of such a model, reference can be made to P. Ramanathan, “Compression and interactive streaming of lightfields,” March 2005, Doctoral Dissertation, Department of Electrical Eng., Stanford University, Stanford Calif., USA, which is fully incorporated herein by reference. Another prediction model involves an advanced linear predictor, namely the Kalman filter, to predict the future viewpoint for interactive 3DTV. For further details of a generic Kalman filter model, reference can be made to E. Kurutepe, M. R. Civanlar, and A. M. Tekalp, “A receiver-driven multicasting framework for 3DTV transmission,” Proc. of 13th European Signal Processing Conference (EUSIPCO), Antalya, Turkey, September 2005, which is fully incorporated herein by reference. The ROI prediction can also include processing the frames of the overview video which are already present in the client's buffer. The motion estimated through the processing of the buffered overview frames can also be combined with the observations of mouse moves to optimize the prediction of the ROI.

If the wrong regions are pre-fetched, then the user's desired ROI can be rendered by interpolating the co-located ROI from the overview video and thereby somewhat concealing the lack of high-resolution image buffering. Typically, this results in a reduction in quality of the rendered ROI. Assuming such a concealment scheme is used, the impact of the ROI prediction can be judged by the mean distortion in the rendered ROI. The lower bound is the mean distortion in the rendered ROT resulting from a perfect prediction of the ROT (i.e., distortion due to only the quantization at the encoder). The upper bound is the mean distortion when the ROT is always rendered via concealment.

In tracking mode, the system is allowed to shape the ROT trajectory at the client's side; the fact that the pre-fetched ROT is simply rendered on the client's screen obviates error concealment when all the pre-fetched slices arrive by the time of rendering. Hence, the distortion in the rendered ROT is only due to the quantization at the encoder. However, it is important to create a smooth and stable trajectory that satisfies the user's expectation of tracking. The application of tracking for reducing the rendering latency is an aspect of various embodiments of the present invention.

An objective of various algorithms discussed hereafter is to predict the user's ROT d frames ahead of the currently displayed frame n. This can include a 3D prediction in two spatial dimensions and one zoom dimension. As discussed above, there can be two modes of operation. In the manual mode the algorithms can be used to process the user's ROT trajectory history up to the currently displayed frame n. In the tracking mode, this source of information may not be relevant, or even exist. In both modes, the buffered overview frames (including n through n+d) are available at the client, as shown in FIG. 3. Thus various algorithms can be used to exploit the motion information in those frames to assist in predicting the ROT.

One algorithm used for manual mode is Autoregressive Moving Average (ARMA) Model Predictor. This algorithm is agnostic of the video content. The straightforward ARMA trajectory prediction algorithm is applied to extrapolate the spatial coordinates of the ROT. Suppose, in the frame of reference of the overview frame, the spatial co-ordinates of the ROT trajectory are given by pₜ=(xₜ, yₜ) for t=0, 1 . . . , n. The velocity vₙ is recursively estimated according to

vₜ=αvₜ₋₁+(1−α)(pₜ−pₜ−1).

The changes to the parameter ‘α’ result in a trade off between the responsiveness to the user's ROT trajectory and the smoothness of the predicted trajectory. The predicted spatial co-ordinates \hat{p}_{n+d}=(\hat{x}_{n+d}, ŷ_{n+d}) of the ROT at frame n+d are given by

\hat{p}_{n+d}=pₙ+dvₙ, (2)

suitably cropped for when they happen to veer off the extent of the overview frame. In a particular instance, the zoom co-ordinate of the ROI is not predicted in this way because the rendering system may have a small number of discrete zoom factors. Instead, the zoom z_{n+d} is predicted at frame n+d as the observed zoom zₙ at frame n.

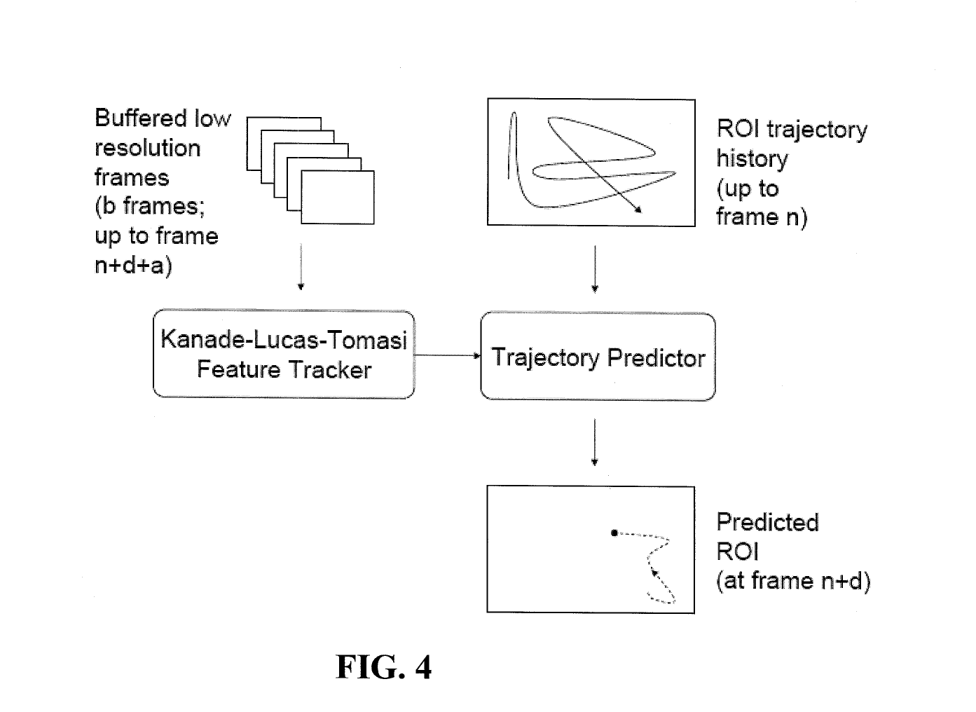

The Kanade-Lucas-Tomasi (KLT) feature tracker based predictor is another example algorithm. This algorithm does exploit the motion information in the buffered overview video frames. As shown in the processing flowchart in FIG. 4, the Kanade-Lucas-Tomasi (KLT) feature tracker is first applied to perform optical flow estimation on the buffered overview video frames. This yields the trajectories of a large (but limited) number of feature points from frame n to frame n+d. The trajectory predictor then incorporates these feature trajectories into the ROT prediction for frame n+d. The following discussion describes aspects of the KLT feature tracker followed by a discussion of the trajectory predictor.

The KLT feature tracker is modified so that it begins by analyzing frame n and selecting a specified number of the most suitable-to-track feature windows. The selection of these feature windows can be implemented as described in C. Tomasi and T. Kanade, “Detection and tracking of point features,” April 1991, Carnegie Mellon University Technical Report CMU-CS-91-132. This implementation tends to avoid flat areas and single edges and to prefer corner-like features. Next the Lucas-Kanade equation is solved for each selected window in each subsequent frame up to frame n+d. Most (but not all) feature trajectories are propagated to the end of the buffer. For additional details regarding the KLT feature tracker reference can be made to Bruce D. Lucas and Takeo Kanade, “An Iterative Image Registration Technique with an Application to Stereo Vision,” International Joint Conference on Artificial Intelligence, pages 674-679, 1981; Carlo Tomasi and Takeo Kanade, “Detection and Tracking of Point Features,” Carnegie Mellon University Technical Report CMU-CS-91-132, April 1991; and Jianbo Shi and Carlo Tomasi, “Good Features to Track,” IEEE Conference on Computer Vision and Pattern Recognition, pages 593-600, 1994, each of which is fully incorporated herein by reference.

The trajectory predictor uses these feature trajectories to make the ROT prediction at frame n+d. Among the features that survive from frames n to n+d, the trajectory predictor finds the one nearest the center of the ROI in frame n. It then follows two basic prediction strategies. The centering strategy predicts spatial co-ordinates centering \hat{p}_{n+d}^{centering} of the ROI to center that feature in frame n+d. The stabilizing strategy predicts spatial co-ordinates stabilizing \hat{p}_{n+d}^{stabilizing} that keep that feature in the same location with respect to the display. The eventual ROI prediction is blended from these two predictions according to a parameter β

\hat{p}_{n+d}^{blended}=β\hat{p}_{n+d}^{centering}+(1+β)\hat{p}_{n+d}^{stabilizing}.

As in the ARMA model predictor, the zoom z_{n+d} is predicted as the zoom zₙ and the predicted spatial coordinates of the ROI are cropped once they veer off the overview frame.

Another aspect involves a predictor that uses the H.264/AVC motion vectors. This prediction algorithm exploits the motion vectors contained in the encoded frames of the overview video already received at the client. From the center pixel of the ROI in frame n, the motion vectors are used to find a plausible propagation of this pixel in every subsequent frame up to frame n+d. The location of the propagated pixel in frame n+d is the center of the predicted ROI. The zoom factor z_{n+d} is predicted as the zoom factor zₙ.

Three example algorithms are provided below for implementing the pixel propagation from one frame to the next frame. These algorithms assume that there is a pixel pₙ in frame n, for propagating to frame n+1 is desired.

Algorithm 1: A pixel in frame n+1 is chosen, which is temporally connected to pₙ via its motion vector. This simple approach is not very robust and the pixel might drift out of the object that needs to be tracked.

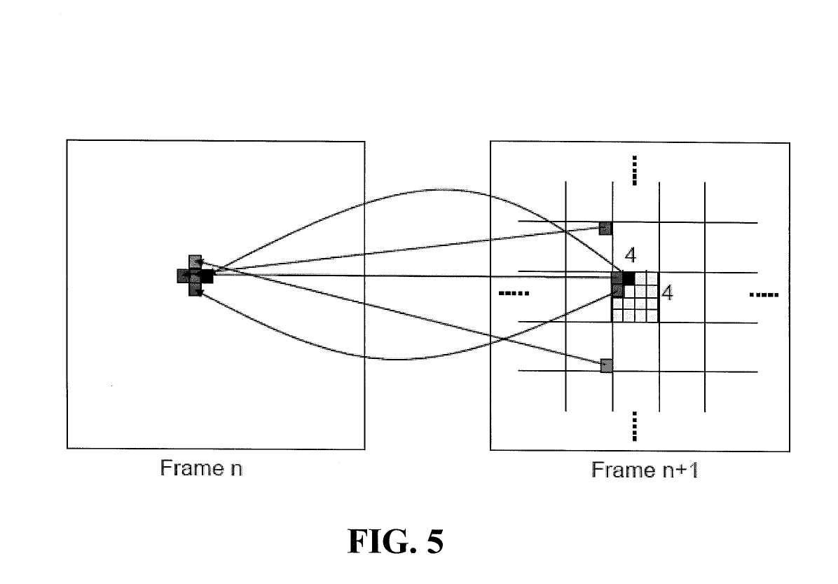

Algorithm 2: In addition to finding a temporally connected pixel for pₙ one temporally connected pixel is also found for each of the pixels in frame n, which are in the spatial 4-connected neighborhood of pₙ. An example is shown in FIG. 5. Out of these five pixels in frame n+1, choose that pixel which minimizes the sum of the squared distances to the remaining four pixels in frame n+1.

Algorithm 3: The five pixels in frame n+1 are found, similar to algorithm 2. Out of these five pixels in frame n+1, a pixel is chosen that has the minimum squared difference in intensity value compared to pₙ.

Note that in the algorithms above, for any pixel, if no connection via motion vectors exists, then the co-located pixel is declared as the connected pixel. Also note that if there are multiple connections then one connected pixel is chosen randomly.

Median Predictor: The different predictors described above are quite diverse and every predictor characteristically performs very well under specific conditions. The conditions are dynamic while watching a video sequence in an interactive session. Hence, several of the above predictors are combined by selecting the median of their predictions, separately in each dimension. This selection guarantees that for any frame interval, if one of the predictors performs particularly poorly compared to the rest, then the median operation does not select that predictor.

In a specific implementation, the algorithms for the tracking mode differ from those for the manual mode in the following manners. Firstly, these algorithms do not expect ongoing ROI information as a function of input from the user. Instead a single click on a past frame indicates the object that is to be tracked in the scene. In certain implementations, the user may still control the zoom factor for better viewing of the object. Consequently, the KLT feature tracker and H.264/AVC motion vectors based predictors are modified, and the ARMA model based predictor may be ruled out entirely, because it is altogether agnostic of the video content. The second difference is that the predicted ROI trajectory in tracking mode is actually presented to the user. This imposes a smoothness requirement on the ROI trajectory for pleasant visual experience.

A variation of the Kanade-Lucas-Tomasi (KLT) feature tracker based predictor can be used. Similar to the manual mode, the KLT feature tracker can be employed to extract motion information from the buffered overview frames. The trajectory predictor again produces a blended ROI prediction from centering and stabilizing predictors. In the absence of ongoing ROI information from the user, both of these predictors begin by identifying the feature nearest the user's initial click. Next, the trajectory of the feature in future frames is followed, centering or keeping the feature in the same location, respectively. Whenever the feature being followed disappears during propagation, these predictors start following the surviving feature nearest to the one that disappeared at the time of disappearance.

Note that the centering strategy can introduce jerkiness into the predicted ROI trajectory each time the feature being followed disappears. On the other hand, the stabilizing predictor is designed to create very smooth trajectories but runs the risk of drifting away from the object selected by the user. The blended predictor trades off responsiveness to motion cues in the video and its trajectory smoothness via parameter β.

An H.264/AVC motion vectors based predictor can also be used. The user's click at the beginning of the tracking mode indicates the object to be tracked. As described herein, the motion vectors sent by the server for the overview video frames are used for propagating the point indicated by the user into the future frames. This predictor sets the propagated point as the center of the rendered ROI. This is different from the KLT feature tracker based predictor because in the KLT feature tracker, the tracked feature might disappear.

Experiments were implemented using three high resolution video sequences, Sunflower, Tractor and Card Game. The following discussion discloses aspects of such experiments, however, for further details of similar experiments reference can be made to Aditya Mavlankar, Pierpaolo Baccichet, David Varodayan, and Bernd Girod, “Optimal Slice Size for Streaming Regions of High Resolution Video with Virtual Pan/Tilt/Zoom Functionality” Proc. of 15th European Signal Processing Conference (EUSIPCO), Poznan, Poland, September 2007 and Aditya Mavlankar, David Varodayan, and Bernd Girod, “Region-of-Interest Prediction for Interactively Streaming Regions of High Resolution Video” Proc. Of 16th IEEE International Packet Video Workshop (PV), Lausanne, Switzerland, November 2007, each of which are fully incorporated herein by reference. The Sunflower sequence of original resolution 1920×1088 showed a bee pollinating a sunflower. The bee moves over the surface of the sunflower. There is little camera movement with respect to the sunflower. In the Tractor sequence of original resolution 1920×1088, a tractor is shown tilling a field. The tractor moves obliquely away from the camera and the camera pans to keep the tractor in view. The Card Game sequence is a 3584×512 pixel 360° panoramic video stitched from several camera views. The camera setup is stationary and only the card game players move.

Sunflower and Tractor are provisioned for 3 dyadic levels of zoom with the ROI display being 480×272 pixels. The overview video is also 480×272 pixels. For Card Game, there are two levels of zoom with the ROI display being 480×256 pixels. The overview video is 896×128 pixels and provides an overview of the entire panorama.

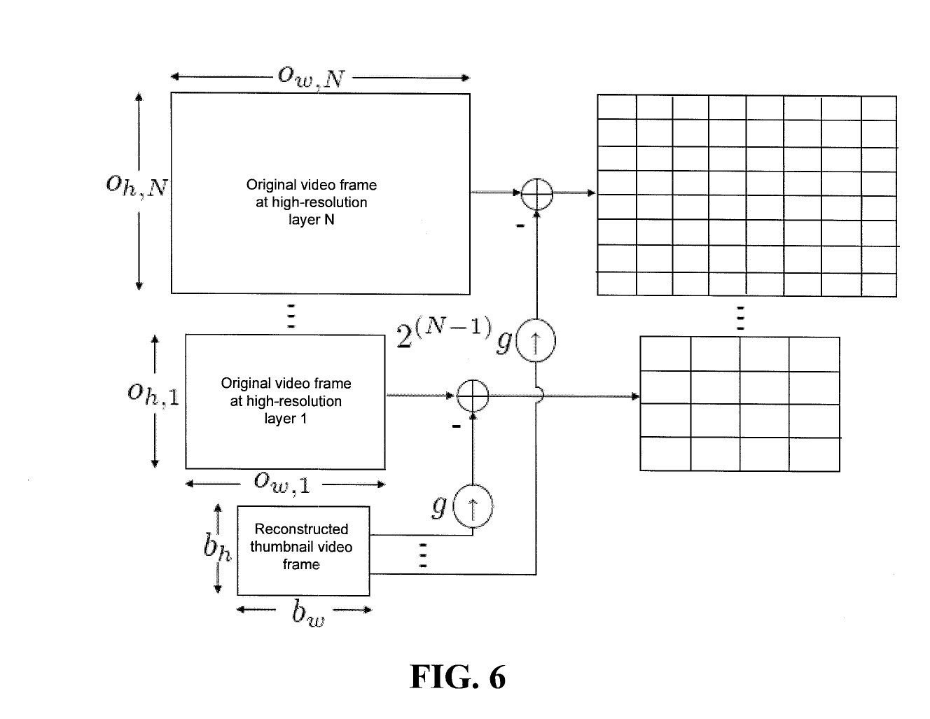

The following video coding scheme was used. Let the original video be o_{w} pixels wide and oₕ pixels tall. Since every zoom-out operation corresponds to down-sampling by two both horizontally and vertically, the input to the coding scheme is the entire scene in multiple resolutions; available in dimensions o_{w,i}=2^{-(N-i)}o_{w} by o_{h,i}=2^{-(N-i)}oₕ for i=1 . . . N, where N is the number of zoom factors. As shown in FIG. 6, the overview video (b_{w} by bₕ) is first encoded using H.264/AVC without B frames. No spatial random access is required within the overview display area. The reconstructed overview video frames are up-sampled by a factor of 2⁽ⁱ⁻¹⁾ g horizontally and vertically and used as prediction signal for encoding video of dimensions (o_{w,i} by o_{h,i}), where i=1 . . . N and

$$g = \frac{{o}_{h , 1}}{{b}_{h}} = \frac{{o}_{w , 1}}{{b}_{w}} .$$

Furthermore, every frame of dimensions (o_{w,i} by o_{h,i}) is coded into independent P slices. This is depicted in FIG. 6, by overlaying a grid on the residual frames. This allows spatial random access to local regions within any spatial resolution. For every frame interval, the request of the client can be responded to by providing the corresponding frame from the overview video and a few P slices from exactly one resolution layer.

Four user ROI trajectories were captured for these sequences, one for Sunflower, two for Tractor and one for Card Game. All trajectories begin at the lowest zoom factor. The Sunflower trajectory follows the bee, at zoom factors 1, 2 and 3 in succession. Trajectory 1 for Tractor follows the tractor mostly at zoom factor 2, and trajectory 2 follows the machinery attached to the rear of the tractor mostly at zoom factor 3. The Card Game trajectory follows the head of one of the players, primarily at zoom factor 2.

The right-click of the mouse was used to select and deselect the tracking mode. The user made a single object-selection click in the middle of each trajectory on the respective object, since the tracked object was always present thereafter until the end of the video. In each of the four ROI trajectories above, in spite of selecting the tracking mode, the user continued to move the mouse as if it were still the manual mode. The mouse coordinates were recorded for the entire sequence. This serves two purposes: evaluation of the manual mode predictors over a greater number of frames; and comparison of the tracking capability of the tracking mode predictors with a human operator's manual tracking.

The manual mode predictors are evaluated based on the distortion per rendered pixel they induce in the user's display for a given ROI trajectory through a sequence. If the ROI prediction is perfect, then the distortion in the rendered ROI is only due to the quantization at the encoder. A less than perfect prediction implies that more pixels of the ROI are rendered by up-sampling the co-located pixels of the overview video. In the worst case, when no correct slices are pre-fetched, the entire ROI is rendered via up-sampling from the base layer. This corresponds to the upper bound on the distortion. Due to the encoding being in slices, there is some margin for error for any ROI predictor. This is because an excess number of pixels are sent to the client depending on the coarseness of the slice grid and the location of the predicted ROI. The slice size for the experiments is 64×64 pixels, except for zoom factor of 1 for Card Game, where it is 64×256 pixels. This is because there is no vertical translation of the ROI possible for zoom factor of 1 for Card Game and hence no slices are required in the distortion per rendered pixel (MSE) vertical direction. With zoom factor of 1 for Sunflower and Tractor, no spatial random access was needed.

Three different ARMA model based predictors were simulated with α=0.25, 0.5 and 0.75, respectively. Among these, the α=0.75 ARMA model based predictor yielded the lowest distortion per rendered pixel. The KLT feature tracker based predictor was set to track 300 features per frame and was tested with β=0, 0.25, 0.5 and 1. Note that β=1 corresponds to the centering strategy and β=0 to the stabilizing strategy. The blended predictor with β=0.25 was the best manual mode predictor in this class. Among the three predictors based on H.264/AVC motion vectors, MV algorithm 2 (which selects the pixel that minimizes the sum of squared distances from the other candidate pixels) performed best in the manual mode.

It was demonstrated that the relative performance of the basic predictors varies significantly depending on the video content, the user's ROI trajectory, and the number of look ahead frames. The median predictor, on the other hand, is often better than its three constituent predictors and is much better than the worst case.

For the Sunflower sequence, the distortion when no correct slices are pre-fetched is about 30 for zoom factor of 2 and 35 for zoom factor of 3. For the Tractor sequence, these numbers are about 46 and 60, respectively. There is no random access for zoom factor of 1. The distortion induced in the rendered ROI by the proposed predictors is closer to that of perfect ROI prediction and hence the distortion upper bounds are omitted in the plots.

The performance of several median predictors was compared, for the Sunflower and Tractor ROI trajectories. The median of 3 predictor is the same as the median of the ARMA model predictor with α=0.75, the KLT feature tracker predictor with β=0.25 and the MV algorithm2 predictor. The median of 5 predictor additionally incorporates the KLT feature tracker predictor with β=0.5 and the MV algorithm 3 predictor. The median of 7 predictor additionally incorporates the ARMA model predictors with α=0.25 and 0.5. A content-agnostic median predictor was also considered; it combines only the three ARMA model predictors of α=0.25, 0.5 and 0.75. It has been shown that the content-agnostic median predictor performs consistently worse than the median predictors that do make use of the video content. Moreover, this effect is magnified relative to the size of look ahead. Another observation is that increasing the number of predictions fed into the median predictor seems to improve performance, but only marginally. This is perhaps because the additional basic predictions are already correlated to existing predictions.

In the tracking mode, the predicted ROI trajectory is pre-fetched and actually displayed at the client. So the evaluation of tracking mode prediction algorithms is purely visual since the user experiences no distortion due to concealment. The predicted ROI trajectory should be both accurate in tracking and smooth. Since the user is not required to actively navigate with the mouse, the ARMA model based predictors were not used. Instead, various KLT feature tracker based predictors, set to track 300 features per frame and the H.264/AVC motion vectors based predictors, were used.

The KLT feature tracking predictors were tested with β=0, 0.25, 0.5 and 1 on trajectory 2 of the Tractor sequence. The centering strategy (β=1) accurately tracks the tractor machinery through the sequence, because it centers the feature in frame n+d that was nearest the center in frame n. But it produces a visually-unappealing jerky trajectory whenever the central feature disappears. On the other hand, the stabilizing (β=0) produces a smooth trajectory because it keeps the nearest-to-center feature in frame n in the same location in frame n+d. The drawback is that the trajectory drifts away from the tractor machinery. Subjective experimentation suggests that the best compromise is achieved by the blended predictor with parameter β=0.25. This blended predictor also works well for the trajectory recorded for the Card Game sequence, but fails to track the bee in the Sunflower sequence.

Tracking with the H.264/AVC motion vectors of the buffered overview video proves to be much more successful. MV algorithm 3, which selects the candidate pixel that minimizes the pixel intensity difference, is particularly robust. In addition to the four recorded trajectories, tracking of several points in each video sequence was implemented starting from the first frame. For example, the MV algorithm 3 was tested for tracking various parts of the tractor. Tracking of a single point was implemented over hundreds of frames of video. In fact, the tracking was so accurate that the displayed ROI trajectory was much smoother than a manual trajectory generated by mouse movements. Factors like camera motion, object motion, sensitivity of the mouse, etc., pose challenges for a human to track an object manually by moving the mouse and keeping the object centered in the ROI. Automatic tracking can overcome these challenges.

For many of the aforementioned examples, it is assumed that the ROI prediction is performed at the client side. If this task is moved to the server, then slightly stale mouse co-ordinates would be used to initialize the ROI prediction since these then would be transmitted from every client to the server. Also the ROI prediction load on the server increases with the number of clients. However, in such a case, the server is not restricted to use low resolution frames for the motion estimation. The server can also have several feature trajectories computed beforehand to lighten real-time operation requirements.

For the given coding scheme, the slice size for every resolution can be independently optimized given the residual signal for that zoom factor. Thus, the following strategy can be independently used for all zoom factors i=1 . . . N. Given any zoom factor, it is assumed that the slices form a regular rectangular grid so that every slice is s_{w} pixels wide and sₕ pixels tall. The slices on the boundaries can have smaller dimensions due to the picture dimensions not being integer multiples of the slice dimensions.

The number of bits transmitted to the client depends on the slice size as well as the user ROI trajectory over the streaming session. Moreover, the quality of the decoded video depends on the Quantization Parameter (QP) used for encoding the slices. Nevertheless, it should be noted that for the same QP, almost the same quality is obtained for different slice sizes, even though the number of bits are different. Hence, given the QP, selection of the slice size can be tailored in order to minimize the expected number of bits per frame transmitted to the client.

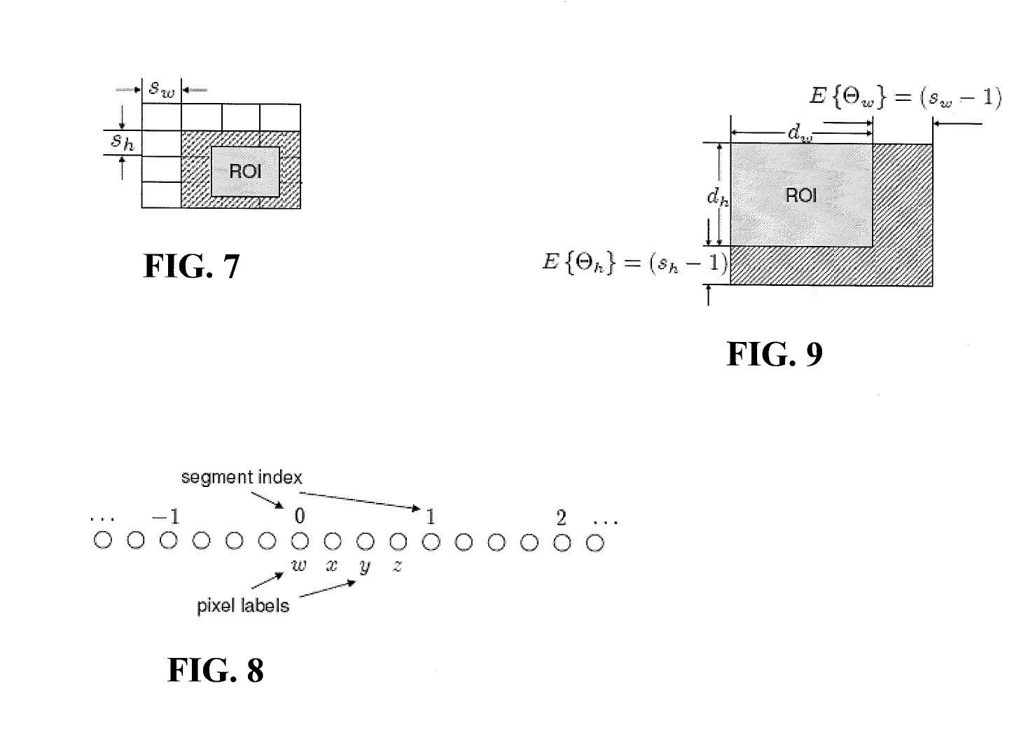

Decreasing the slice size has two contradictory effects on the expected number of bits transmitted to the client. On one hand, the smaller slice size results in reduced coding efficiency. This is because of increased number of slice headers, lack of context continuation across slices for context adaptive coding and inability to exploit any inter-pixel correlation across slices. On the other hand, a smaller slice size entails lower pixel overhead for any ROI trajectory. The pixel overhead consists of pixels that have to be streamed because of the coarse slice division, but which are not finally displayed at the client. For example, the shaded pixels in FIG. 7 show the pixel overhead for the shown slice grid and location of the ROI.

In the following analysis, it is assumed that the ROI location can be changed with a granularity of one pixel both horizontally and vertically. Also every location is equally likely to be selected. Depending on the application scenario, the slices might be put in different transport layer packets. The packetization overhead of layers below the application layer, for example RTP/UDP/IP, has not been taken into account but can be easily incorporated into the proposed optimization framework.

To simplify the analysis, the 1-D case is first considered and then the analysis is extended to 2-D. An analysis of overhead in 1-D involves considering an infinitely long line of pixels. This line is divided into segments of lengths. For example, in FIG. 8, s=4. Also given is the length of the display segment d. It is assumed that d=3 in this example. In order to calculate the pixel overhead, the probability distribution of the number of segments that need to be transmitted is considered. This can be obtained by testing for locations within one segment, since the pattern repeats every segment. For locations w and x, a single segment needs to be transmitted, whereas for locations y and z, 2 segments need to be transmitted. Let N be the random variable representing the number of segments to be transmitted. Given s and d, it is possible to uniquely choose m, d*⊃IN such that m≧0 and 1≦d*≦s and also the following relationship holds:

d=ms+d*.

By inspection, the p.m.f. of random variable N is given by

$$Pr \{ N = m + 1 \} = \frac{s - ( {d}^{*} - 1 )}{s} , \\ Pr \{ N = m + 2 \} = \frac{{d}^{*} - 1}{s}$$

and zero everywhere else.
Given that d, s⊃IN, the expected pixel overhead increases monotonically with s and is independent of d.

### Proof: From the p.m.f. of N,

$$\begin{matrix}E \{ N \} = ( m + 1 ) \frac{s - ( {d}^{*} - 1 )}{s} + ( m + 2 ) \frac{{d}^{*} - 1}{s} \\ = ( m + 1 ) + \frac{{d}^{*} - 1}{s}\end{matrix}$$

Let P be the random variable which denotes the number of pixels that need to be transmitted and Θ be the random variable which denotes the pixel overhead in 1-D.

$$\begin{matrix}E \{ P \} = s \times E \{ N \} \\ = ( m + 1 ) s + {d}^{*} - 1 \\ = d + s - 1 \\ E \{ Θ \} = E \{ P \} - d \\ = s - 1\end{matrix}$$

The expected overhead in 1-D is s−1. It increases monotonically with s and is independent of the display segment length d.

An analysis of overhead in 2-D involves defining two new random variables, viz., Θ_{w}, the number of superfluous columns and Θₕ, the number of superfluous rows that need to be transmitted. Θ_{w} and Θₕ are independent random variables. From the analysis in 1-D it is known that E{Θ_{w}}=s_{w}−1, E{Θₕ}=sₕ−1.

FIG. 9 depicts the situation by juxtaposing the expected column and row overheads next to the ROI display area (d_{w} by dₕ). The expected value of the pixel overhead is then given by

E{Θ}=(s_{w}−1)(sₕ−1)+dₕ(s_{w}−1)+d_{w}(sₕ−1)

and depends on the display area dimensions. Let random variable P denote the total number of pixels that need to be transmitted per frame for the ROI part. The expected value of P is then given by

E{P}=(d_{w}+s_{w}−1)(dₕ+sₕ−1)

Coding efficiency can be accounted for as follows. For any given resolution layer, if the slice size is decreased then more bits are needed to represent the entire scene for the same QP. The slice size (s_{w}, sₕ) can be varied so as to see the effect on η, the bit per pixel for coding the entire scene. In the following, η is written as a function of (s_{w}, sₕ).

Finally, the optimal slice size can be obtained by minimizing the expected number of bits transmitted per frame according to the following optimization equation:

$$\begin{matrix}( {s}_{w} , {s}_{h} ) = arg {min}_{( {s}_{w} , {w}_{h} )} η ( {s}_{w} , {s}_{h} ) \times E \{ P \} \\ = arg {min}_{( {s}_{w} , {s}_{h} )} η ( {s}_{w} , {s}_{h} ) \times ( {d}_{w} + {s}_{w} - 1 ) ( {d}_{h} + {s}_{h} - 1 )\end{matrix}$$

In order to simplify the search the variation of q can be modeled as a function of (s_{w}, sₕ) by fitting a parametric model to some sample points. For example,

η(s_{w},sₕ)=η₀−γs_{w}−φsₕ−λs_{w}sₕ

is one such model with parameters η₀, γ, Ø and λ. This is, however, not required if the search is narrowed down to a few candidate pairs (s_{w}, sₕ). In this case η can be obtained for those pairs from some sample encodings.

In practice, the slice dimensions are multiples of the macro block width. Also slice dimensions in a certain range can be ruled out because they are very likely to be suboptimal, e.g., sₕ greater than or comparable to dₕ is likely to incur a huge pixel overhead. Consider a case where some resolution layer, o_{h,i}=dₕ, i.e., the ROI can have only horizontal translation and no vertical translation. In this case, the best choice for sₕ is sₕ=o_{h,i}=dₕ. Constraints such as these can be helpful in narrowing down a search. Knowing η(s_{w}, sₕ), the optimal slice size can be obtained (e.g., using the optimization equation) without actually observing the bits transmitted per frame over a set of sample ROI trajectories.

Two 1920×1080 MPEG test sequences were used, Pedestrian Area and Tractor, and the resolution was converted to 1920×1088 pixels by padding extra rows. A third sequence is a panoramic video sequence called Making Sense and having a resolution 3584×512. For Making Sense the ROI is allowed to wrap around while translating horizontally, since the panorama covers a full 360 degree view. For the first two sequences, there are 3 zoom factors, viz., (o_{w,1}=480×o_{h,1}=272), (o_{w,2}=960×o_{h,2}=544) and (o_{w,3}=1920×o_{h,3}=1088). The display dimensions are (b_{w}=480×bₕ=272) and (d_{w}=480×dₕ=272). There is no need for multiple slices for zoom factor of 1. For the panoramic video, there are 2 zoom factors, viz., (o_{w,1}=1792×o_{h,1}=256) and (o_{w,2}=3584×o_{h,2}=512). The display dimensions are (b_{w}=896×bₕ=128) and (d_{w}=480×dₕ=256). The overview area shows the entire panorama. For a zoom factor of 1, sₕ=256 is the best choice because the ROI cannot translate vertically for this zoom factor.

The overview video, also called a base layer, is encoded using hierarchical B pictures of H.264/AVC. The peak signal to noise ratio (PSNR) @ bit-rate for Pedestrian Area, Tractor and Making Sense are 32.84 dB @ 188 kbps, 30.61 dB @ 265 kbps and 33.24 dB @ 112 kbps, respectively. For encoding the residuals at all zoom factors, QP=28 was chosen. This gives high quality of reconstruction for all zoom factors; roughly 40 dB for both Pedestrian Area and Tractor and roughly 39 dB for Making Sense.

For every zoom factor, the residual was encoded using up to 8 different slice sizes and calculate η(s_{w}, sₕ) for every slice size. The optimal slice size is then predicted by evaluating the optimization equation. For Pedestrian Area, the optimal slice size, (s_{w}, sₕ), is (64×64) for both a zoom factor of 2 and zoom factor of 3. For Tractor zoom factor of 2, the cost function is very close for slice sizes (64×64) and (32×32). For Tractor zoom factor of 3, the optimal slice size is (64×64). For Making Sense, the optimal slice sizes are (32×256) and (64×64) for zoom factor of 1 and zoom factor of 2 respectively.

To confirm the predictions from the model, 5 ROI trajectories within every resolution layer were recorded using the user interface discussed above and the bits used for encoding the relevant slices that need to be transmitted according to the trajectories were added. It was found that the predictions using the optimization equation are accurate. This is shown in Table 1 for the two sequences Pedestrian Area and Making Sense.

TABLE 1

| Resolution | Slice size | J₁(s_{w}, sₕ) | J₂(s_{w}, sₕ) | f(s_{w}, sₕ) | Resolution | Slice size | J₁(s_{w}, sₕ) | J₂(s_{w}, sₕ) | f(s_{w}, sₕ) |
|---|---|---|---|---|---|---|---|---|---|
| (o_{w,i} × o_{h,i}) | s_{w} × sₕ | kbit/frame | kbit/frame | % | (o_{w,i} × o_{h,i}) | s_{w} × sₕ | kbit/frame | kbit/frame | % |
| 960 × 544 | 160 × 160 | 76.6 | 70.2 | 4 | 1792 × 256 | 256 × 256 | 70.6 | 74.9 | 1 |
| (Zoom | 128 × 128 | 69.0 | 62.7 | 7 | (Zoom | 128 × 256 | 58.8 | 62.8 | 2 |
| factor 2) | 64 × 64 | 57.3 | 53.0 | 18 | factor 1) | 64 × 256 | 53.6 | 57.6 | 4 |
| | 32 × 32 | 63.1 | 59.6 | 53 | | 32 × 256 | 52.0 | 56.0 | 7 |
| 1920 × 1088 | 160 × 160 | 50.4 | 45.2 | 8 | 3584 × 512 | 256 × 256 | 91.5 | 95.7 | 3 |
| (Zoom | 128 × 128 | 45.9 | 40.6 | 12 | (Zoom | 128 × 128 | 59.1 | 67.7 | 9 |
| factor 3) | 64 × 64 | 41.2 | 37.6 | 34 | factor 2) | 64 × 64 | 49.8 | 61.5 | 25 |
| | 32 × 32 | 52.0 | 49.2 | 99 | | 32 × 32 | 57.2 | 70.8 | 70 |

Also, the sequence Pedestrian Area was encoded directly in resolution 1920×1088 using the same hierarchical B pictures coding structure that was used for the base layer in the above experiments. To achieve similar quality for the interactive ROT display as with the random access enabled bit streams above, a transmission bit-rate which is roughly 2.5 times was required.

This a video coding scheme allows for streaming regions of high resolution video with virtual pan/tilt/zoom functionality. It can be useful for generating a coded representation which allows random access to a set of spatial resolutions and also arbitrary regions within every resolution. This coded representation can be pre-stored at the server and obviates the necessity for real-time compression.

The slice size directly influences the expected number of bits transmitted per frame. The slice size has to be optimized in accordance with the signal and the ROT display area dimensions. The optimization of the slice size can be carried out given the constructed base layer signal. However, a joint optimization of coding parameters and QPs for the base layer and the residuals of the different zoom factors may reduce the overall transmitted bit-rate further.

It should be noted that in some realistic networks, the ROT requests on the back channel could also be lost. A bigger slice size will add robustness and help to render the desired ROT at the client in spite of this loss on the back channel. Also, if the packetization overhead of lower layers is considered when each slice needs to be put in a different transport layer packet, then a bigger slice size is more likely to be optimal. A sample scenario is application layer multicasting to a plurality of peers/clients where each client can subscribe/unsubscribe to requisite slices according to its ROI.

A specific embodiment of the present invention concerns distributing multimedia content, e.g., high-spatial-resolution video and/or multi-channel audio to end-users (an “end-user” is a consumer using the application and “client” refers to the terminal (hardware and software) at his/her end) attached to a network, like the Internet. Potential challenges are a) clients might have low-resolution display panels or b) insufficient bandwidth to receive the high-resolution content in its entirety. Hence, one or more of the following interactive features can be implemented.

Video streaming with virtual pan/tilt/zoom functionality allows the viewer to watch arbitrary regions of a high-spatial-resolution scene and/or selective audio. In one such system, each individual user controls his region-of-interest (ROI) interactively during the streaming session. It is possible to move the ROI spatially in the scene and also change the zoom factor to conveniently select a region to view. The system adapts and delivers the required regions/portions to the clients instead of delivering the entire acquired audio/video representation to all participating clients. An additional thumbnail overview can be sent to aid user navigation within the scene.

Aspects of the invention include facilitating one or more of: a) delivering a requested portion of the content to the clients according to their dynamically changing individual interests b) meeting strict latency constraints that arise due to the interactive nature of the system and/or c) constructing and maintaining an efficient delivery structure.

Aspects of the protocols discussed herein also work when there is little “centralized control” in the overlay topology. For example, the protocols can be implemented where the ordinary peers take action in a “distributed manner” driven by their individual local ROI prediction module.

P2P systems are broadly classified into tree-based and mesh-based approaches. Mesh-based systems entail more co-ordination effort and signaling overhead since they do not push data along established paths, such as trees. The push approach of tree-based systems is generally suited for low-latency.

There are several algorithms related to motion analysis in the literature that can be employed for effective ROI prediction. This applies to both the manual mode as well as the tracking mode. Tracking is well-studied and optimized for several scenarios. These modules lend themselves for inclusion within the ROI prediction module at the client.

A particular embodiment involves a mesh-based protocol that delivers units. A unit can be a slice or a portion of a slice. The co-ordination effort to determine which peer has which unit can be daunting. Trees are generally more structured in that respect.

As mentioned herein, various algorithms can be tailored for the video-content-aware ROI prediction depending on the application scenario.

The interactive features of the system help obviate the need for human camera-operators or mechanical equipment for physical pan/tilt/zoom of the camera. It also gives the end-user more flexibility and freedom to focus on his/her parts-of-interest. An example scenario involves Interactive TV/Video Broadcast: Digital TV will be increasingly delivered over packet-switched networks. This provides an uplink and a downlink channel. Each user will be able to focus on arbitrary parts of the scene by controlling a virtual camera at his/her end.

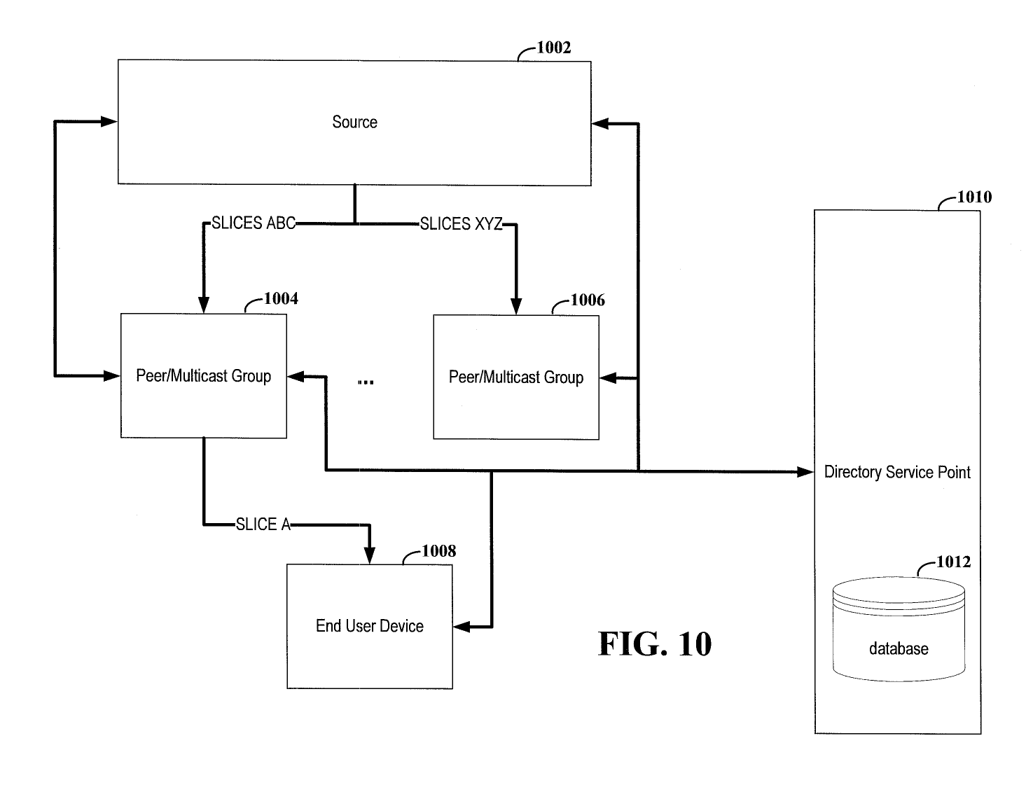

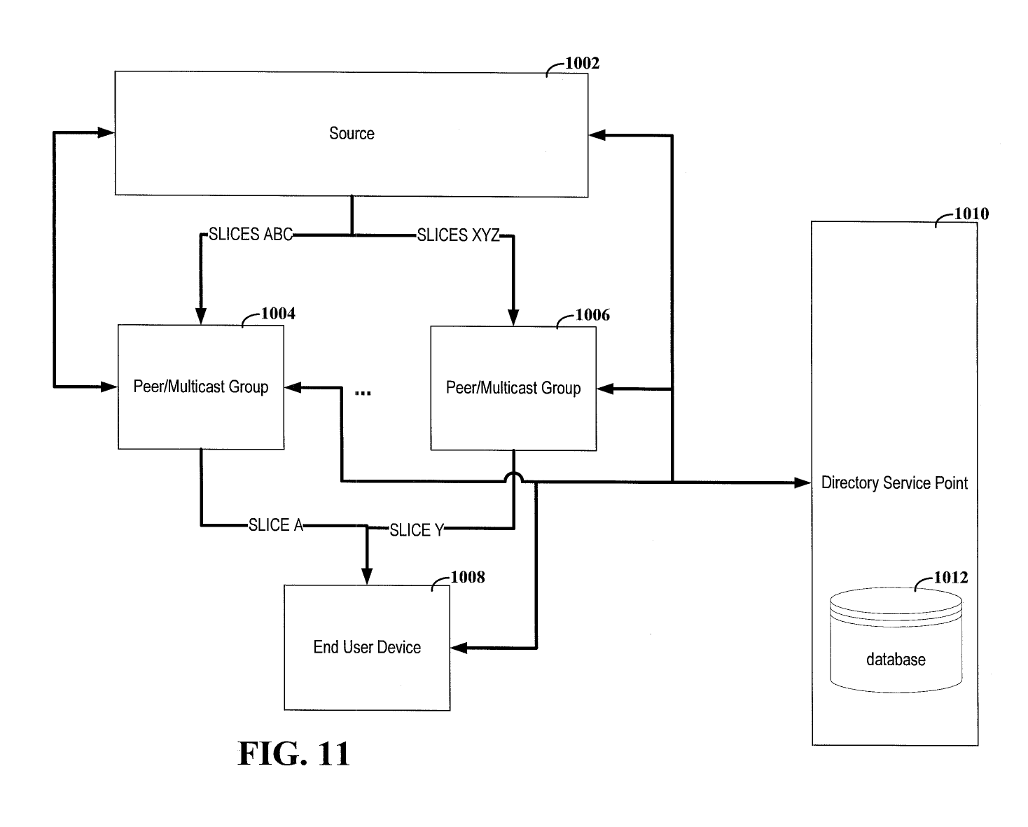

FIGS. 10 and 11 shows block diagrams of a network system for delivering video content that is consistent with various embodiments of the present invention.

At the source 1002, the video content is encoded (e.g., compressed) in individually decodable units, called slices. A user's desired ROI can be rendered by delivering a few slices out of the pool of all slices; e.g., the ROI of the client determines the set of required slices. For example, multiple users may demand portions of the high-resolution content interactively. For efficient delivery to multiple end-users, it is beneficial to exploit the overlaps in the ROIs and to adapt the delivery structure. Aspects of the present invention involve dynamically forming and maintaining multicast groups to deliver slices to respective clients.

There is a rendezvous point, Directory Service Point (DSP) 1010, that helps users to subscribe to their requisite slices. Aspects of the invention are directed to scenarios both where the network layer provides some multicasting support and where it does not provide such support.

If the network layer provides multicasting support, the clients join and leave multicast sessions according to their ROIs. For obtaining information such as which slices are available on which multicast session, and also which slices are required to render a chosen ROI, the clients receive input from the rendezvous point. A particular multicast group distributes portion of (or all) data from a particular slice. For example, multicast group 1004 receives and is capable of distributing slices A, B and C, while multicast group 1006 receives and distributes slices X, Y and Z.

If the system does not rely on multicasting functionality provided by the network layer, then multicasting can still be achieved to relieve the data-transmission burden on the source with growing client/peer population. In a specific instance, a protocol is proposed to be employed on top of the common network layers. The protocol exploits the overlaps in the ROIs of the peer population and thereby achieves similar functionality as a multicasting network. This protocol system may be called overlay multicast protocol, since it forms an overlay structure to support a connection from one point to multi-point.

In this case, the system consists of a source peer 1002, 1004 or 1006, an ordinary peer (End User Device) 1008 and a directory service point 1010. The source has the content; real-time or stored audio/video. The directory service point acts as the rendezvous point. It maintains a database 1012 of which peer is currently subscribed to which slice. The source can be one or more servers dedicated to providing the content, one or more peers who are also receiving the same content or combinations of peers and dedicated servers.

Data distribution tree structures (called trees henceforth) start at the source 1002. A particular tree aims to distribute a portion of (or all) data from a particular slice. For obtaining information such as a) which slices are available on which multicast trees, b) which slices are required to render a chosen ROI, and also c) a list of other peers currently subscribed to a particular slice, the ordinary peers can take the help of the directory service point. Ordinary peers can also use data from the directory service point (DSP) 1010 to identify slices that are no longer required to render the current ROI and unsubscribe those slices.

One mechanism useful for reducing the signaling traffic is as follows. Whenever the ROI changes, the ordinary peer 1008 can indicate both old and new ROIs to the DSP 1010. If the ROIs are rectangular, then this can be accomplished, for example, by indicating two corner points for each ROI. The DSP 1010 then determines new slices that form part of the new ROI and also slices that are no longer required to render its new ROI. The DSP can then send a list of peers 1004, 1006 corresponding to the slices (e.g., from a database linking slices to peers) to the ordinary peer 1008. The list can include other peers that are currently subscribed to the new slices and hence could act as potential parents. The DSP can optionally update its database by assuming that the peer will be successful in updating its subscriptions. Or, optionally, the DSP could wait for reports from the peer about how its subscription update went.

After receiving such a list, the ordinary peer can communicate with potential parents and attempt to select one or more parents that can forward the respective slice to it. Such a list of potential parents can include the source peer as well as other ordinary peers.

When a peer decides to leave or unsubscribe a particular tree, it can send an explicit “leave message” to its parent and/or its children. The parent stops forwarding data to the peer on that tree. The children contact the DSP to obtain a list of potential parents for the tree previously provided by the leaving peer.

In one instance, periodic messages are exchanged by a child peer and its parent to confirm each other's presence. Confirmation can take the form of a timeout that occurs after a set period of time with no confirming/periodic message. If a timeout detects the absence of a parent then the peer contacts the DSP to obtain a list of other potential parents for that tree. If a timeout detects the absence of a child then the peer stops forwarding data to the child. Periodic messages from ordinary peers to the DSP are also possible for making sure that the DSP database is updated.

For example, FIG. 10 shows an end user device 1008 with a current ROI that includes slice A. The device 1008 receives slice A from peer/multicast group 1004, which also has slices B and C. FIG. 11 shows the same end user device 1008 with a modified ROI that includes slices A and Y. This could be from movement of the ROI within the overview image and/or from modifying the zoom factor. Device 1008 receives slice A from peer/multicast group 1004 and slice Y from peer/multicast group 1006. In order to receive the new slice Y, device 1008 can provide an indication new slice requirements (i.e., slice Y) to DSP 1010. DSP 1010 retrieves potential suppliers of slice Y from database 1012 and can forward a list of one or more of the retrieved suppliers to device 1008. Device 1008 can attempt to connect to the retrieved suppliers so that slice Y can be downloaded. Apart from connecting to new suppliers, if a peer detects missing packets for any slice stream from a particular supplier, the peer can request local retransmissions from other peers that are likely to have the missing packets.

Since, in one implementation, the user is allowed to modify his/her ROI on-the-fly/interactively while watching the video, it is reasonable to assume that the user may expect to see the change in the rendered ROI immediately after operating the modification at the input device (for example, mouse or joystick). In a multicast scenario, this means that new multicast groups or multicast trees need to be joined immediately to receive the data required for the new ROI. However, typically, the “join process” consumes time. As a solution, aspects of the present invention predict the user's future ROI a few frames in advance and pro-actively pre-fetch relevant data by initiating the join process in advance. If data of a certain slice does not arrive by the time of displaying the ROI, up sampling (if needed) of corresponding pixels of the thumbnail overview can be used to fill in for the missing data.

In a particular instance, prediction of the user's future ROI includes both monitoring of his/her movements on the input device and also processing of video frames of the thumbnail overview. A few future frames of the overview video can be made available to the client at the time of rendering the display for the current frame. These frames are used as future overview frames (either decoded or compressed bit-stream) that are available in the client's buffer at the time of displaying the current frame. The ROI prediction can thus be video-content-aware and is not limited to extrapolating the user's movements on the input device.

In a first “manual mode”, the user actively navigates in the scene and the goal of the ROI prediction and pre-fetching mechanism is to pro-actively connect to the appropriate multicast groups or multicast trees beforehand in order to receive data required to render the user's explicitly chosen ROI in time. Alternatively, the user can choose the “tracking mode” by clicking on a desired object in the video. The system then uses this information and the buffered thumbnail overview frames to track the object in the video, automatically maneuver the ROI, and driving the pro-active pre-fetching. The tracking mode relieves the user of navigation burden; however, the user can still perform some navigation, change the zoom factor, etc.

Real-time traffic like audio/video, even when the user is not interactively choosing to receive selective portions of the content, is often characterized by strict delivery deadlines. The use of interactive features, with such deadlines implies that certain data flows have to be terminated and new data flows have to be initiated often and on-the-fly.

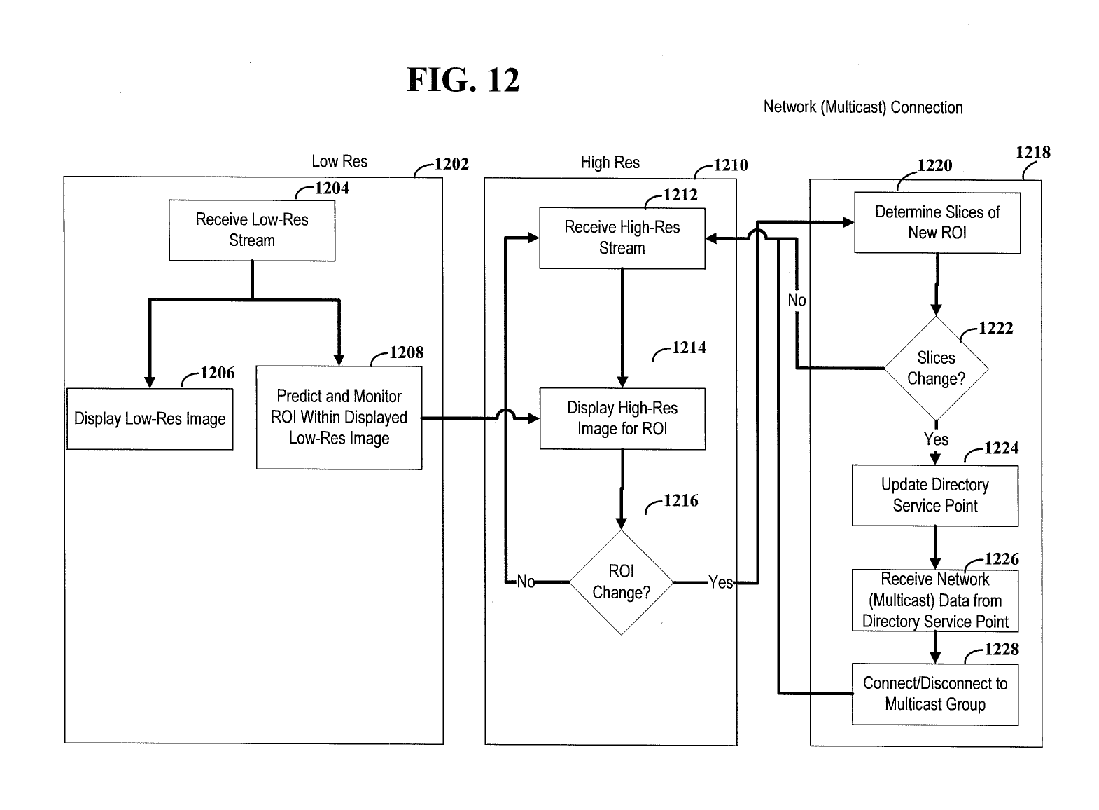

FIG. 12 shows a flow diagram for an example network implementation, consistent with an embodiment of the present invention. The flow-diagram assumes that a low-resolution overview image is being used. This portion of the flow diagram is shown by the steps of section 1202. The high-resolution portion from the selected ROI is shown by the steps of section 1210, whereas, the network connection portion is shown by the steps of section 1218.

While each of sections 1202, 1210 and 1218 interact with one another, they also, in some sense, operate in parallel with one another. The end user device receives the low-resolution video images at step 1204. As discussed herein, a sufficient number of the (low-resolution video) images can be buffered prior to being displayed.

Low-resolution video image data is received at block 1204. This data is buffered and optionally displayed at step 1206. The buffered data includes low-resolution video image data that has not yet been displayed. This buffered data can be used at step 1208 to predict future ROI position and size. Additionally, the actual ROI location information can be monitored. This information, along with previous ROI location information can also be used as part of the future ROI prediction.

High-resolution video image data is received at block 1212. This data is buffered and displayed at step 1214. The displayed image is a function of the current ROI location. If the prediction from step 1208 was correct, high-resolution video image data should be buffered for the ROI. At step 1216, there is a determination of whether the ROI has changed. If the ROI has not changed, the current network settings are likely to be sufficient. More specifically, the slices being currently received and the source nodes from which they are received should be relatively constant, assuming that the network topology does not otherwise change.

Assuming that the current ROI was accurately predicted and the network was able to provide sufficient data, there should be high-resolution data in the buffer. In this situation, the ROI checked at step 1216 is a predicted ROI. For example, if the currently displayed high-resolution image is image number 20, and the buffer contains data corresponding to image numbers 21-25, the ROI check in step 1216 is for any future image number 21+. In this manner, if the ROI prediction for image numbers 21-25 changes from a previous prediction, or the predicted ROI for image 26 changes from image 25, the process moves to step 1220.

Another possibility is that the ROI prediction was not correct for the currently displayed ROI. In such an instance, it is possible that there is insufficient buffered data to display the current ROI in high resolution. The process then moves to step 1220. Even though there may not be high resolution data for the current ROI, the current ROI can still be displayed using, for example, an up conversion of the low resolution image data. The missing data (and therefore the up conversion) could be for only subset of the entire image or, in the extreme case, for the entire image. It is also possible that the image display be paused until high resolution data for the current ROI is received. This trade off between high-resolution and continuity of the display can be determined based upon the particular implementation including, but not limited to, a user-selectable setting.

At step 1220 a determination is made as to which new slices are necessary to display the new ROI. At step 1222 a decision is made as to whether the new slices are different from the currently received slices. If the new slices are not different, then the current network configuration should be sufficient. The process then continues to receive the high-resolution frames. If the new slices contain a new slice and/or no longer need each of the previous slices, the process proceeds to step 1224. At step 1224, the directory service point is contacted and updated with the new slice information requirements. The directory service point provides network data at step 1226. This network data can include a list of one or more peers (or multicast groups) that are capable of providing appropriate slices. At step 1228, connections are terminated or started to accommodate the new slice requirements. The high-resolution data continues to be received at step 1212.

According to one embodiment, the high-resolution streams are coded using the reconstructed and up-converted low-resolution thumbnail as prediction. In this case, the transmitted low-resolution video can also be displayed to aid navigation. In another embodiment, it is not necessary to code the high-resolution slices using the thumbnail as prediction and hence it is not necessary to transmit the thumbnail to the client.

In one such embodiment, the user device performs the ROI prediction using buffered high-resolution frames instead or simply by extrapolating the moves of the input device. As an example, this would involve using high-resolution layers that are dyadically spaced in terms of spatial resolution. These layers can be coded independently of a thumbnail and independently of each other. In a specific instance each frame from each resolution layer can be intraframe coded into I slices, which are decodable independent of previous frames. Depending on the user's region-of-interest (ROI), the relevant I slices can be transmitted from the appropriate high-resolution layer. With a sufficiently accurate ROI prediction, even where a user changes his/her ROI at any arbitrary instant, the corresponding transmitted slices can be decoded independently. This is due, in part, to a property of the I slices that allows them to be decoded independently. Specifically I slices are coded without using any external prediction signal.

In one instance, the source has available a stack of successively smaller images, sometimes called a Gaussian pyramid. An arbitrary portion from an image at any one of these scales can be transmitted in this example.

Another example involves the uses of image-browsing capability of the JPEG2000 standard. Each frame of the highest spatial resolution can be coded independently using a critically sampled wavelet representation, such as JPEG2000. Unlike the Gaussian pyramid of the scheme discussed above, this scheme has fewer transform coefficients stored at the server. To transmit a region from the highest resolution or any dyadically (i.e., downconverted by a factor of two both horizontally and vertically) downsampled resolution, the server and/or client selects the appropriate wavelet coefficients for transmission. This selection is facilitated (e.g., in JPEG2000) because blocks of wavelet coefficients are coded independently.

Consistent with another example embodiment, the high-resolution layers, which can be dyadically spaced in terms of spatial resolution, are coded independently of a thumbnail and independently of each other. However, unlike the examples above, successive frames from one layer are not coded independently (e.g., using P or SP frames); motion compensation exploits the redundancy among temporally successive frames. A set of slices, corresponding to the ROI, is transmitted. It is not desirable for the motion vectors needed for decoding a transmitted slice to point into not-transmitted slices. Thus multiple-representations coding is used. For example, an I-slice representation is maintained as well as a P-slice representation for each slice. The P slice is transmitted if motion vectors point to data that are (or will be) transmitted to the client. The I-slice representation and the P-slice representation for a slice might not result in the exact same reconstructed pixel values; this can cause drift due to mismatch of prediction signal at encoder and decoder. The drift can be stopped periodically by transmitting I slices.

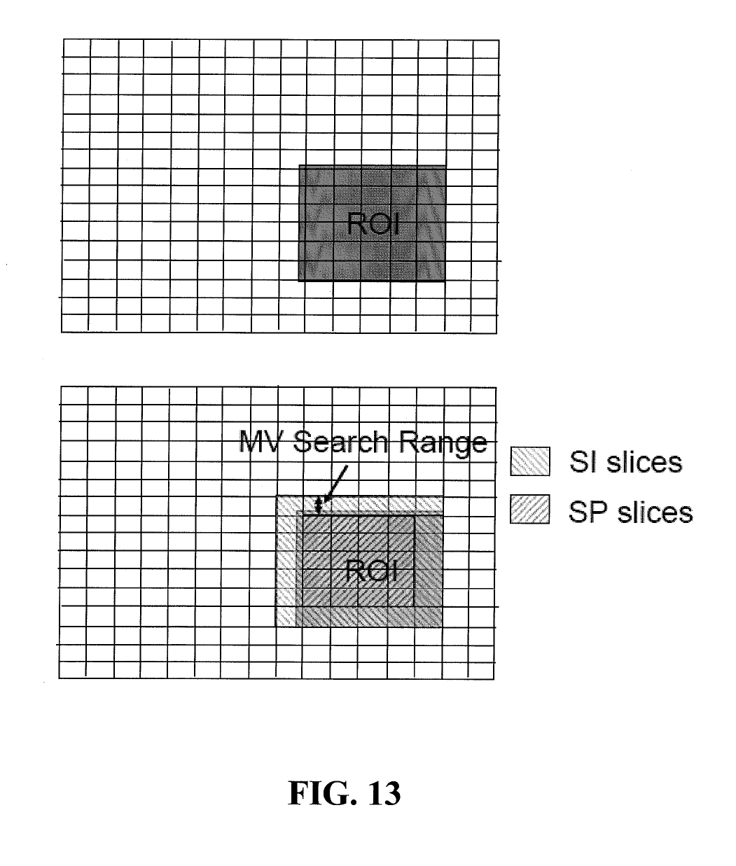

One way to compensate for drift (or to avoid drift all together) is to use multiple-representations coding based on two new slice types (SP and SI), as defined in the H.264/AVC standard. For further details on such coding including multiple-representations coding, reference can be made to M. Karczewicz and R. Kurceren, “The SP- and SI-Frames Design for H.264/AVC,” IEEE Trans. Circuits and Systems for Video Technology, Vol. 13, No. 7, July 2003, which is fully incorporated herein by reference. FIG. 13 shows an example where the ROI has been stationary for multiple few frames. The slices for which the SP-slice representation is chosen for transmission have their motion vectors pointing within the bounding box of slices for the ROI.

Consistent with another example embodiment, a thumbnail video is coded using multiple-representations coding and slices. The coding of the high-resolution layers uses the reconstructed and appropriately up-sampled thumbnail video frame as a prediction signal. However, rather than transmitting the entire thumbnail, less than all of the slices are transmitted (e.g., only the slices corresponding to the ROI are transmitted). This scheme exploits the correlation among successive frames of the thumbnail video. This scheme can be particularly useful because, in a multicasting scenario, even though users have different zoom factors and are receiving data from different dyadically spaced resolution layers, the slices chosen from the thumbnail are likely to lead to overlap, which enhances the efficiency/advantage of multicasting.

According to various embodiments, pan/tilt/zoom functions of a remote camera can be controlled by a number of different users. For instance, tourism boards allow users to maneuver a camera via a website interface. This allows the user to interactively watch a city-square, or ski slopes, or surfing/kite-surfing areas, etc. Often, only one end-user controls the physical camera at a time. Aspects of the present invention can be useful for allowing many users to watch the scene interactively at the same time. Another example involves an online spectator of a panel discussion. The spectator can focus his/her attention on any individual speaker in the debate/panel. Watching a classroom session with virtual pan/tilt/zoom is also possible. In another example, several operators can control virtual cameras in the same scene at the same time to provide security and other surveillance functions by each focusing on respective objects-of-interest. Another potential use associated with aspects of the invention is IPTV service providers; for instance, an interactive IPTV service that allows the viewer to navigate in the scene. Broadcasting over a campus, corporation or organization network is another possible use. One such example is broadcasting a company event to employees and allowing them to navigate in the scene. Yet another implementation involves multicasting over the Internet. For instance, aspects of the invention can be integrated with existing Content Delivery Network (CDN) infrastructure to build a system with more resources at the source peer(s), providing interactive features for Internet broadcast of “live” and “delayed live” events, such as a rock concert broadcast with virtual pan/tilt/zoom functionality.

The various embodiments described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such modifications and changes do not depart from the true spirit and scope of the present invention.

What is claimed is:

1. A method for use with a streaming video source, the video source providing streaming data to a user device, the streaming data representative of a sequence of images, each image including a plurality of individually decodable slices, the method comprising:
at the user device and for a particular image and a corresponding subset region of the image, displaying less than all of the plurality of individually decodable slices in response to a current input indicative of the subset region; and
predicting future input indicative of a revised subset region in response to images in the image sequence that have yet to be displayed and to previously received input.

2. The method of claim 1, wherein the current input indicative of the subset region includes a user selection via a graphical interface, and before the step of predicting future input, further including the step of buffering the images in the image sequence that have yet to be displayed.

3. The method of claim 1, wherein the current input indicative of the subset region is in response to data indicative of a tracked object.

4. The method of claim 1, wherein the images in the image sequence that have yet to be displayed include thumbnail images.

5. The method of claim 1, wherein the streaming data to a user device includes data representing a thumbnail version of the sequence of images and data representing a higher resolution version of the corresponding subset region of the image.

6. The method of claim 5, wherein the thumbnail version is used for display of the subset region in response to at least one of the prediction of the future input being incorrect and data corresponding to the subset region not arriving on time.

7. The method of claim 1, wherein the step of predicting future input includes the use of motion information obtained from the images in the image sequence that have yet to be displayed.

8. The method of claim 1, wherein the step of predicting future input includes computing a median of multiple predictions obtained through multiple motion vectors.

9. The method of claim 8, wherein predicting future input includes the use of three distinct motion prediction algorithms, each motion prediction algorithm providing a predicted motion.

10. A method for use with a streaming video source that provides an image sequence, the video source providing low-resolution image frames and sets of higher-resolution image frames, each of the higher-resolution image frames corresponding to a respective subset region that is within the low-resolution image frames, the method comprising:
receiving input indicative of a subset region of an image to be displayed;
displaying the indicated subset region using the higher-resolution image frames; and
predicting future input indicative of a revised subset region of the low-resolution image sequence in response to image frames not yet displayed and to previous input indicative of a subset region of the low-resolution image sequence.

11. A method for providing streaming video to a plurality of user devices, the streaming video portioned into a plurality of individually decodable slices, the method comprising:
providing less than all of the individually decodable slices to a particular peer, the provided less than all of the individually decodable slices corresponding to a region of interest;
displaying the region of interest at the particular peer;
receiving input indicative of a change in the region of interest;
responsive to the input, generating a list of video sources that provide at least one slice of the changed region of interest; and
responsive to the list of video sources, connecting the particular peer to one or more of the video sources to receive a slice of the subset of the plurality of slices.

12. The method of claim 11, wherein the list of video sources include at least one dedicated server and one peer.

13. A user device for use with a streaming video source, the video source providing streaming data to a user device, the streaming data representative of a sequence of images, each image including a plurality of individually decodable slices, the user device comprising:
a display for, at the user device and for a particular image and a corresponding subset region of the image, displaying less than all of the plurality of individually decodable slices in response to a current input indicative of the subset region; and
a processor arrangement for predicting future input indicative of a revised subset region in response to images in the image sequence that have yet to be displayed and to previously received input.

14. The device of claim 13, wherein the current input indicative of the subset region includes a user selection via a graphical interface, and further includes a memory arrangement for buffering the images in the image sequence that have yet to be displayed.

15. The device of claim 13, wherein the processor arrangement uses the current input in response to data indicative of a tracked object.

16. The device of claim 13, wherein the images in the image sequence that have yet to be displayed include thumbnail images.

17. The device of claim 13, wherein the streaming data to the user device includes data representing a thumbnail version of the sequence of images and data representing a higher resolution version of the corresponding subset region of the image.

18. The device of claim 17, wherein the thumbnail version is used for display of the subset region in response to at least one of the prediction of the future input being incorrect and data corresponding to the subset region not arriving on time.

19. The device of claim 13, wherein the processor arrangement is adapted to use multiple and distinct motion prediction algorithms.

20. A user device for use with a streaming video source that provides an image sequence, the video source providing low-resolution image frames and sets of higher-resolution image frames, each of the higher-resolution image frames corresponding to a respective subset region that is within the low-resolution image frames, the user device comprising:
a display device for displaying, in response to input indicative of a subset region of an image to be displayed, the indicated subset region using the higher-resolution image frames; and
a data processing arrangement for predicting future input indicative of a revised subset region of the low-resolution image sequence in response to image frames not yet displayed and to previous input indicative of a subset region of the low-resolution image sequence.

21. A user device for providing streaming video to a plurality of user devices, the streaming video portioned into a plurality of individually decodable slices, the user device comprising:
a network-communication computer-based module for serving a particular network peer with less than all of the individually decodable slices, said served individually decodable slices corresponding to a region of interest;
a display arrangement for displaying the region of interest at the particular peer;
a data processor arrangement for
generating, in response to receiving input indicative of a change in the region of interest, a list of video sources that provide at least one slice of the changed region of interest; and
connecting, in response to the list of video sources, the particular peer to one or more of the video sources to receive a slice of the subset of the plurality of slices.

22. A computer readable medium containing data that when executed by a processor performs a method for use with a streaming video source, the video source providing streaming data to a user device, the streaming data representative of a sequence of images, each image including a plurality of individually decodable slices, the method comprising:
at the user device and for a particular image and a corresponding subset region of the image, displaying less than all of the plurality of individually decodable slices in response to a current input indicative of the subset region; and
predicting future input indicative of a revised subset region in response to images in the image sequence that have yet to be displayed and to previously received input.

23. A computer readable medium containing data that when executed by a processor performs a method for providing streaming video to a plurality of user devices, the streaming video portioned into a plurality of individually decodable slices, the method comprising:
providing less than all of the individually decodable slices to a particular peer, the provided less than all of the individually decodable slices corresponding to a region of interest;
displaying the region of interest at the particular peer;
receiving input indicative of a change in the region of interest;
responsive to the input, generating a list of video sources that provide at least one slice of the changed region of interest; and
responsive to the list of video sources, connecting the particular peer to one or more of the video sources to receive a slice of the subset of the plurality of slices.
